(19) United States
(12) Patent Application Publication
(10) Pub. No.: US 2009/0192918 A1
(43) Pub. Date: Jul. 30, 2009

(54) Lead Mining Systems and Methods

(76) Inventors: Michael Hood, Irvine, CA (US); Michael Khristo, Irvine, CA (US)

Correspondence Address: FISH & ASSOCIATES, PC;ROBERT D. FISH, 2603 Main Street, Suite 1000, Irvine, CA, 92614-6232, US

(21) Appl. No.: 12/355,983

(22) Filed: Jan. 19, 2009

Related U.S. Application Data
(60) Provisional application No. 61/022,486, filed on Jan. 21, 2008.
(60) Provisional application No. 61/022,484, filed on Jan. 21, 2008.

(51) Int. Cl. G06Q 30/00; G06Q 50/00

(52) U.S. Cl. 705/27; 705/26

(57) ABSTRACT

Lead mining services and methods are presented. A lead mining service stores leads having attributes, a history, or a closing value in a database and allows lead consumers to defined policies for acceptable leads. The service provides leads to the lead consumers according to their defined lead policies. Each consumer can work a lead by modifying lead attributes, or closing values. Based on how consumers work leads, an analytic engine associated with the service can discover or establish trends from leads having acceptable closing values. The trend information can be used to form a predication comprising a set of one or more leads that are predicted to have acceptable closing values for the lead consumers were the set of leads fail to satisfy the consumer's lead policies. Contemplated lead mining services identify leads that would ordinarily be overlooked or fall outside the scope of a lead policy.

This application claims the benefit of priority to U.S. Provisional Application having Ser. No. 61/022,484 filed on Jan. 8, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is lead mining technologies.

### BACKGROUND

Many entities (e.g., businesses, companies, organizations, non-profits, etc.) that advertise their messages (e.g. goods, services, political information, or other messages) seek alternative avenues for contacting prospects beyond simple advertising. One avenue of getting their message out includes purchasing leads from a lead source. For example, one can purchase or sell leads through companies similar to Leadpile™ (http://www.leadpile.com). Unfortunately, purchased leads are often of very poor quality where only one or two percent of the leads convert into revenue or otherwise have a positive closing value.

Leadpile attempts to improve the quality of leads by allowing various purchasers and sellers to interact through their service while buying, selling, or auctioning leads. The hope is the quality of leads obtained by a purchaser is improved because a purchaser can define filters for leads or select from whom to purchase within their price range. Still, the quality of leads remains low.

An ideal lead mining system would allow many, possibly unrelated, entities to work a common pool of leads. As each entity works the leads in the system, the system could monitor the lead flow to predict when leads will become valuable to others.

Others have also attempted to address various aspects of lead improvement or mining. For example, U.S. Pat. No. 7,035,699 to Anderson et al. discusses a lead selection and delivery system for use by multiple agents. The system delivers leads to the agents from a server based upon agents' preferences and lead selection parameters. The parameters limits the overall number of leads a user can receive at one time, as well as the type of leads. When closing leads, agents can provide information regarding any resulting sales and how the lead was contacted. Anderson fails to provide predicting when leads will become valuable.

International Patent Application Publication WO 2000/072210 to Burgh et al. discusses an automated system for accepting, prioritizing, and routing customer leads. The leads are routed based upon user preferences and system rules. Users can add to the leads' information to keep track of the success and failure of leads. Although Burgh provides for routing leads, the contemplated system also lacks any predictive power.

Another example includes U.S. Pat. No. 7,047,212 to Pych et al. Pych discusses a system for storing prospect lists of at least one list manager. A list purchaser can utilize a user interface to select and purchase a prospect list. A privacy policy can be used to limit access to the prospect lists by the list purchaser. However, Pych also fails to provide for a lead mining service having predicative capabilities.

International Patent Application Publication WO 2008/057853 to Williams et al. is another example of a lead mining. Williams discusses a method of enhancing leads of a client. The client first submits the leads to the system which then enhances the leads and returns them to the client. The lead might be enhanced through one or more processes, including a score representing the likelihood that contact information provided is correct. In addition, leads can be filtered to eliminate fake leads as well as duplicates. Williams also lacks any predictive power.

U.S. Patent Application Publication 2007/0233559 to Golec has made some progress toward a predictive lead mining service. Golec discusses a system that scores leads based upon a business's criteria. The leads are first scored for each business based upon its criteria. Next, the system provides leads having a score exceeding a score threshold to the business for a fee. If the business rejects the leads, the system might offer the leads to another business. However, Golec merely predicts a sales revenue from leads as opposed to offering a predication that a set of leads will be valuable based on attributes modified by the community

U.S. Pat. No. 7,302,430 to Nabe et al. makes further progress toward a desirable lead mining service. Nabe discusses an auction system for supplying customer leads to dealers. The system predicts the chance of customers responding to an offer and when those customers will respond to that offer. A list of customers is then generated and then provided to one or more dealers through an auction process. However, Nabe fails to allow multiple lead consumers to work a common set of leads by modifying lead attributes and to predict when leads will become valuable to others.

What has yet to be appreciated is that leads can be considered a dynamic product having various value attributes, other than just price, that can change through time and be used to determine when a lead will become valuable to other entities even if the lead fails to match the entity's acceptance criteria. As entities work a lead, value attributes of the lead can be added, removed, changed, or otherwise modify, which can result in increasing the value of the lead to other entities. Armed with the additional new value attributes, the lead can then be routed to an entity who has expressed interest in leads having in the new value attributes. Furthermore, the leads can be analyzed as they flow from acceptance to closing to determine the lead characteristics having the greatest value to various lead consumers. The analysis can be used to predict which leads will likely have a desirable closing value without requiring the leads to match an a prior defined policy that outlines desirable lead characteristics.

Unless a contrary intent is apparent from the context, all ranges recited herein are inclusive of their endpoints, and open-ended ranges should be interpreted to include only commercially practical values.

Thus, there is still a need for lead mining where a lead's value attributes can be modified by a plurality of lead consumers.

### SUMMARY OF THE INVENTION

The inventive subject matter provides apparatus, systems and methods in which lead mining services can be provided. In one aspect of the inventive subject matter the service can be provided by storing leads in a lead database. Preferred leads are assigned value attributes, a lead history, and a closing value of the lead. Lead consumers are allowed to define criteria for drawing leads from the database based on the various information assigned to the leads. Leads satisfying a lead consumer's criteria can be provided to the lead consumer for review. Additionally, other lead consumers can also work leads in the lead database by modifying the lead attributes or lead closing values. As leads are worked by multiple lead consumers, the leads can be analyzed with respect to their attributes, history, or closing values to form a predication comprising leads that would likely, at some point in time, be valuable to other lead consumers. The prediction set of leads can be presented to a lead consumer, even if the leads in the predication set do not a prior satisfy the consumer's criteria, via a computer interface (e.g., application software, web interface, application programming interface, web service, etc.). The prediction set can be updated periodically, even in near-real time, in a number of ways including updating graphical or text tag clouds, displayed lists, spreadsheets, rankings, or other presentations.

Another aspect of the inventive subject matter includes a lead mining system comprising one or more computers configured to allow lead consumers to obtain leads, work the leads, or submit leads back to the system. Preferred lead mining systems include a lead database that stores leads along with relevant information describing the leads including attributes, history, closing values or other information. In addition, contemplated systems include one or more interfaces to allow lead consumers to interact with the system. Interfaces can include a policy interface that allows lead consumers to define rules outlining desirable lead criteria, an attribute interface that allows a plurality of lead consumers to modify attributes of the lead, or a computer interface through which leads that are predicted to be valuable can be presented. It is also contemplated that a lead mining system can include an analytics engine configured to monitor leads flowing through the system or to create a predication when leads are predicted to have desirable closing values.

As used herein “lead” represents at least a contact identifier of an individual where the individual can be a person, a household, a business, or other type of prospect. The contact identifier can include a name, phone number, email address, or other information that can be used to contact the individual. Preferred contact identifiers imply a method of contact (e.g. a phone number, email address, profession association, group membership, etc.). It should be noted that a lead is not merely a sales lead but rather can includes all types of leads for which an entity could be interested in contacting. The purpose for obtaining leads can include sales, marketing, political campaigning, philanthropy, or other for reasons.

As used herein “entity” means an individual that is interested in the buying or selling of leads as opposed to the individual to which the lead refers. Generally, an entity is a person, business, or company that wishes to contact an individual. Within this document “entity” is used to reference entities interested in leads as a commodity. “Individual” is used to reference as the individual to which the leads refers.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic overview of an environment where lead consumers utilize a lead mining service.

FIG. 2 is an illustration of a lead consumer defining a lead policy.

FIG. 3 illustrates a schematic of an example attribute interface.

FIG. 4 is a schematic of a lead mining service having an analytics engine capable of forming a prediction set of leads.

FIG. 5 illustrates a schematic of a computer interface where a prediction set of leads is presented to a lead consumer.

FIG. 6 is a schematic of a method of providing a lead mining service.

### DETAILED DESCRIPTION

The following description of lead mining services includes several simple examples to illustrate the inventive concepts. One skilled in the art will appreciate that the number or character of the various disclosed elements or techniques can vary while still falling within the scope of the inventive subject matter.

Overview

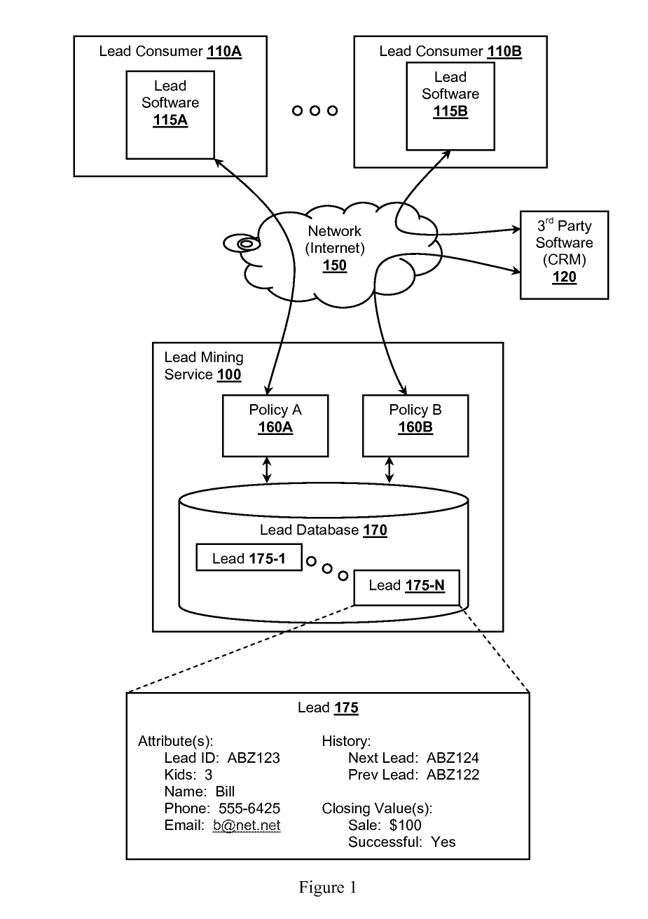

In FIG. 1, lead mining service 100 provides one or more lead consumers 110A through 110B access to leads 175-1 through 175-N, referred to as leads 175. In a preferred embodiment service 100 includes lead database 170 that stores leads 175. Lead consumers 110A through 110B, referred to as consumers 110, can define which of leads 175 are of interest by defining rules in their respective policies 160A and 160B. Service 100 provides leads 175 to consumers 110 according to their respective policies 160. In a preferred embodiment, consumers 110 interact with service 100 over network 150, preferably the Internet. Each consumer 110 can utilize lead software 115A or 115B to work a lead obtained from service 100. In some embodiments, a consumer works leads through third party software 120. For example, consumer 110B obtains leads indirectly via customer relationship management (CRM) software.

Lead consumers 110 represent various entities that express interest in obtaining leads from service 110. Consumers 110 can be a business, an organization, a person, or other entity that can utilize leads. In a preferred embodiment, service 100 accepts a fee from consumers 110 in exchange for providing leads 175.

Lead mining service 100 preferably comprises one or more computer systems having hardware or software configured to offer the disclosed services. Software instructions can be stored in a memory capable of persistent storage and can be executed by suitable hardware. Preferred computer systems include one or more servers adapted to communicate with consumers 110 over the Internet, possibly offering the disclosed services via a web service. The preferred computer systems also offer substantially permanent storage of lead 175 in database 170. Database 170 can be stored on any suitable storage system including a network attached storage (NAS) device, a storage area network (SAN), a RAID system, hard disk, or other storage device.

In a preferred embodiment, leads 175 are stored in database 170. Database 170 can be implemented based on known database software. Example suitable database software includes MicroSoft™ Access™, MySQL™, PostgresSQL™, Oracle™, proprietary database, or other database software known or yet to be created. Although database 170 is shown as being located remote to consumers 110, it is also contemplated that database 170 could comprise multiple, possibly distributed, databases hosted by various elements in the over all system. For example, a third party hosting software 120 could host one part of a database 170. Furthermore, leads 175 are illustrated as being centrally located in database 170. However, it is also contemplated that leads could migrate from service 100 to consumers 110 or to other entities in the system. Leads 175 can migrate by physically moving lead data from one location to another, copying lead data, or flagging lead data as “belonging” to one of consumers 110. Migrating leads 175 in some form provides additional support for establishing a lead consumer's exclusive use of a lead or ownership of a lead.

Policies 160A through 160B, referred to as policies 160, are preferably defined by consumers 110 as discussed below. Although policies 160 are illustrated as being stored within service 100, one should appreciate policies 160 could be stored or execute at any location in the system. For example, consumer 110A could store policy 160A local. When consumer 110A wishes to obtain leads, consumer 110A can query database 170 over network 150 based on rules defined within policy 160A. Additionally, policy 160B for consumer 110B could be stored at a third party site along with software 120. It is contemplated that a third party could aggregate one or more policies 160 to provide optimized services for down stream consumers.

Third party software 120, when used by consumers 160, preferably offers additional capabilities beyond those offered by service 100. The services offered by service 100 can enhance the capabilities of software 120 or can be enhanced by software 120. Contemplated software 120 can include CRM software, customer support software, or other software packages. Software 120 can be locally hosted or remotely hosted by consumer 110B. An example of locally hosted third party software includes Prophet™ offered by Advidian Technologies that can be integrated with Microsoft Outlook. Example CRM tools include those offered by Salesforce™ (http://www.salesforce.com), SAP™, Siebel™, Oracle™, Sugar™, or Amdocs™.

A preferred leading mining service 100 is a for fee service. As lead consumers 110 use the lead mining service to obtain, work, analyze, or route leads using the service, consumers 110 pay for access to the service. Any form of payment is suitable including a subscription, per lead fees, a percentage of brokered leads, or other forms of payment.

A preferred lead mining service 100 also allows consumers 110 to obtain leads through purchasing the leads. Leads can be purchased by auction, direct sale between a selling consumer and the purchasing consumer, buying in bulk, buying individual leads, exchanging one set of leads for another set, or other suitable purchasing methods.

Leads 175 are stored in database 170 using any suitable schema. In a preferred embodiment, a lead 175 is assigned various data values that can be leveraged by lead mining service 100 or consumers 110. Preferred data includes attributes, lead histories, or closing values of the leads.

Lead Attributes

Leads 175 are preferably assigned one or more value attributes, sometimes referred to as “attributes”. Value attribute can be assigned to each lead individually or to a group collectively.

Value attributes represent characteristics of a lead and can include nearly any piece of information that consumers 110 would find valuable to increase the closing value of leads 175. Preferred value attributes are those that are associated with the value drivers of consumers 160 interested in the leads. For example, a mortgage broker lead consumer could use a type of mortgage as a value attribute. Alternatively, a political candidate could use a party affiliation as a value attribute. Example value attributes can include attributes pertaining to geographic information, demographic information, psychographic information, interests, hobbies, or other information.

Value attributes preferably include a (tag, value) pair where the tag is an identifier that can be represented by alphanumeric data and where the value represents a numeric, or possibly logical, value of the tag. One should note that “value” in the (tag, value) pair is used in the computer science meaning of the word as opposed to “value attribute” which is used in a economic sense. Although a preferred value in a (tag, value) pair is logical or numerical, it is also contemplated that the value can include other data representations including strings, enumerations, or other structures. In some embodiments, a value can be a multi-valued array of data to indicate various aspects associated with a tag. It is also contemplated that attributes can be optionally meta-tagged with metadata that describes the attributes. For example, an attribute could have a meta-tag that represents the entity that created the attribute, a standardized name for the tag, a time stamp, or other metadata.

A value attribute could include a tag represented by the string “Pool?” and the value could be represented logically as 0 for “no” and 1 for “yes”. Such a logical value attributes can be represented in a user interface as a simple check box associated with the tag. An alternative example of a value attribute includes a tag “Kids” where the value can be 0, 1, 2, or more depending on the number of children the individual associated with the lead has.

Contemplated attributes that are considered to be useful for leads 175 include comment fields, names, preferred contact methods, possibly lead history, or possibly even closing values.

Lead Histories

A lead history represents the context of a lead 175 as it flows through service 100 or from consumer 110A to consumer 110B. A lead history can include one or more pieces of information describing various states of the lead. Lead history information can include origination of a lead, various time stamps, previous owners of the lead, modification history, current state or past states that a lead has pass through while being worked, or other information regarding the previous existence of a lead.

A lead history can be assigned to a lead individually, collectively as a group, or assigned via interrelating leads. An example of interrelating leads includes forming a chain of leads to form a lead history. In some embodiments, when a lead is closed by a lead consumer, a new lead is created by copying relevant attributes from the closed lead to the fields of the new lead. The new lead can then be linked to the previously closed lead. Such an approach provides for closing a lead with respect to a consumer while also retaining the lead by allowing other lead consumers access to the lead. The lead history for a lead can then comprise a chain of leads where each lead in the chain represents a previous incarnation.

Lead history can be stored within the content of a lead, possibly using value attributes. It is also contemplated that lead history can be stored as metadata describing the lead as opposed to being lead content. In a preferred embodiment, lead history information stored as metadata that can be accessed by only authorized entitles, possibly only service 100. It is also possible to allow consumers 110 to purchase access to lead history.

In preferred embodiment, lead history information is assigned to a lead automatically by service 100. As consumers 110 work a lead by updating attributes or closing values, service 100 determines when or what history information to update.

Closing Values

In a preferred embodiment, consumers 110 can update one or more closing values associated with leads 175. Closing values represent a data field of a lead indicating how consumers 110 finished working a lead. Preferred closing values comprise a monetary value. However, it is contemplated that a closing value could be just about any data considered pertinent to consumer 110A or 110B.

In some embodiments, closing values are treated as a value attribute. A closing value attribute could be tagged with a string of “closing value” and then assigned a value to form a tag-value pair. In a preferred embodiment, a lead's closing value is flagged by service 100 to distinguish it from other data fields, possibly by a meta-tag. Such an approach allows service 100 to readily identify and analyze the closing values of lead regardless of how consumers 110 label the “closing value” data field.

It should be noted that a lead can have more than on closing value. For example, lead 175 has two closing values include a monetary value and a success indicator.

Lead Polices

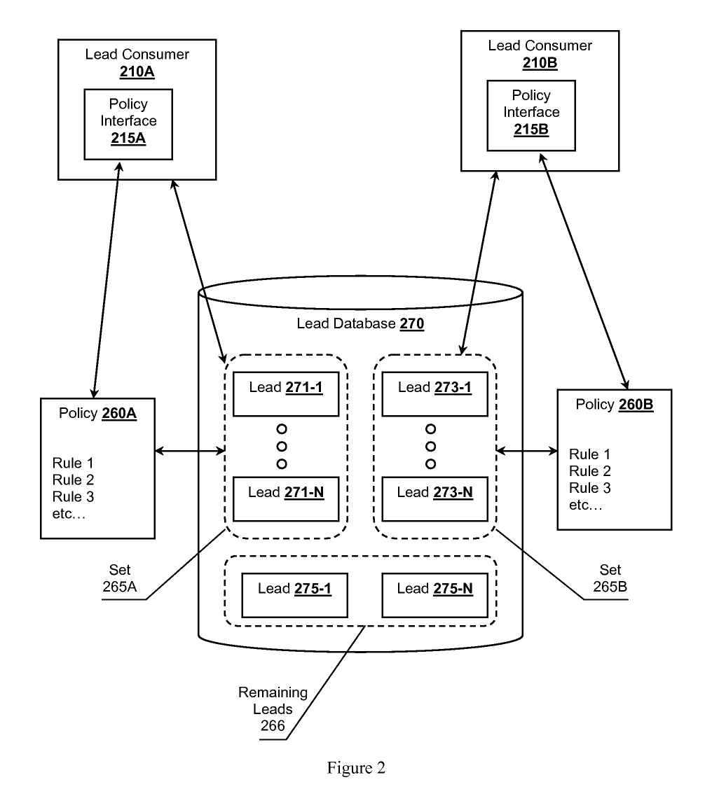

In FIG. 2, one or more of lead consumers 210A through 210B, referred to as consumers 210, use policy interfaces 215A and 215B to define lead polices 260A and 260B, respectively. Policies 260 (e.g., policies 260A through 260B) preferably include one or more rules defining desirable characteristics of leads in database 270.

Consumers 210 preferably use interface 215 to define one or more rules to form criteria that leads should satisfy. The rules, and as a result polices 260, operate as a function of lead attributes. It is also contemplated that the rules could function based on closing values or lead history. However, it some embodiments such information could be restricted. The rules could be based on simple requirements for various attributes (e.g., “Kids”==3, “Pool?”==True, etc.) using known computer science logical operators. Rules could be quite complex and can include programmatic instructions, possibly using scripting or SQL languages, that are used to query database 270.

In some embodiments, policies 260 include time-based condition with respect to lead attributes. Time-based conditions represent an absolute time or a relative time to a condition or event. Absolute times indicate a specified time or time frame. For example, consumer 210A could define policy 260A to include a rule that requires all leads having zip code attributes in a certain range between the dates of January 2008 and November 2009. The expressed times are absolute times. An example of a relative time could include a condition where an individual associated with a lead pays off a loan within three months of obtaining a loan, where the three month time frame is relative an event.

Policy interfaces 215 (e.g., policy interface 215A and 215B) can be provided to consumers 210 in any suitable manner. In a preferred embodiment, interfaces 215 can comprise a web interface (e.g., web page, web services application program interface, etc.). Example policy interfaces can include a search engine interface, a web page offering a form to be filled out, a drag and drop application, or other interfaces.

In some embodiments, consumer 260A is allowed to use interface 215A to define new attributes, preferably in the form of tag-value pairs. The new attributes could be meta-tagged as belonging exclusively to consumer 210A, or could be meta-tagged for use by another lead consumer, possibly lead consumer 210B. Providing for newly created attributes allows consumer 260A to work leads and improve leads in a manner that drives toward a desired value. Although the newly create attributes are available on leads satisfying policy 260A (e.g., set 265A) it is also contemplated that the newly created attributes can be made available for modification on remaining leads 266 that fall outside the scope of set 265A as defined by policy 260A, or even made available on leads falling within set 265B.

In a preferred embodiment, a lead mining service allows lead consumers 210 to define policies 260 via policy interfaces 215 by authenticating consumers 210. Authentication can be based on exchange of passwords, tokens, keys, certificates, or other data that can be used to indicate identify of each party. Suitable authentication means include Kerberos, RADIUS, OpenID, Diameter protocol, encrypted key exchange, HMAC, or other authentication methods.

Policies 260 can be executed locally or remotely relative to consumers 210, where the term “execute” is used euphemistically to mean applying a policy to database 270 to obtain a set of one or more leads that satisfy the policy. In some embodiments, policy interfaces 215 include software applications capable of storing and executing policies 260 locally at a consumer site or on a consumer computer. In other embodiments, the lead mining service can remotely execute policies 260 by applying policies 260 locally to database 270. It is also contemplated that policies 260 can be executed remotely by a third party; a business, company, or organization owned by someone other than the owner of the consumer or lead mining service.

Although policies 260 preferably include rules for filtering leads from database 270, it is also contemplated that policies 260 can include rules governing other aspects of leads beyond filtering. Rules can also be defined that determine which attributes should be displayed while working leads. For example, lead consumer 210A could require that only attributes associated with children be display while all others are ignored, or that only attributes originally created by consumer 210A be displayed while ignoring other attributes created by another consumer 210B. Such rules can be applied based on an attribute's tag, value, meta-tag, or other attribute information. Polices 260 could also comprise exclusion or inclusion lists which specifically exclude or include leads, respectively.

In some embodiments polices 260 can include rules to control a lead flow rate. Consumer 210A can defined a desire flow rate at which to receive leads within policy 260A. Additionally, consumer 210A can establish a range of acceptable values for lead value attribute. The range can be used by the lead mining service to establish a cut level for leads where the cut level falls within the range. As the flow rate of leads waxes or wanes, the mining service can adjust the cut level within the range to cause the flow rate to more closely match the consumer's desired flow rate.

Once polices 260 are defined, the policies can be applied to database 270 to generate one or more sets of leads. As shown, lead set 265A comprising leads 271-1 through 271-N is provided to consumer 210A and lead set 265B comprising leads 273-1 through 273-N is provided to consumer 210B. Although set 265A and 265B are shown as having no overlap, it is contemplated that leads could be in more than one set, subject to exclusivity agreements. If one of lead consumers 210 purchases exclusive use of leads, the exclusivity information can be used as part of an exclusion list associated with policies 260.

Polices 260 can be executed once or multiple times as desired by consumers 210A or 210B, assuming consumers 210 purchased an appropriate level of service. In a preferred embodiment, a lead mining service is capable of applying policies 260 periodically to database 270 to capture any new leads entering the system, or to capture any old leads that have been updated causing the old leads to satisfy one of policies 260. Policies 260 can be executed irregularly (e.g., when commanded by a lead consumer) or regularly. Examples of regularly executing policies 260 include applying policies 260 hourly, daily, weekly, monthly, quarterly, or even yearly. It is specifically contemplated that sets 265A or 265B could be updated to reflect changes in database 270, possibly in near real-time (e.g., within ten minutes of detecting new leads satisfying a policy).

Remaining leads 266 comprising leads 275-1 through 275-N are leads in database 270 that do not match a consumer's lead policy. It should be noted that although leads 266 are illustrated as failing to satisfy policy 260A and 260B, leads 275-1 through 275-N could satisfy other policies from other consumers. Even so, they would still be considered remaining leads 266 with respect to consumers 210A or 210B.

Attribute Interface

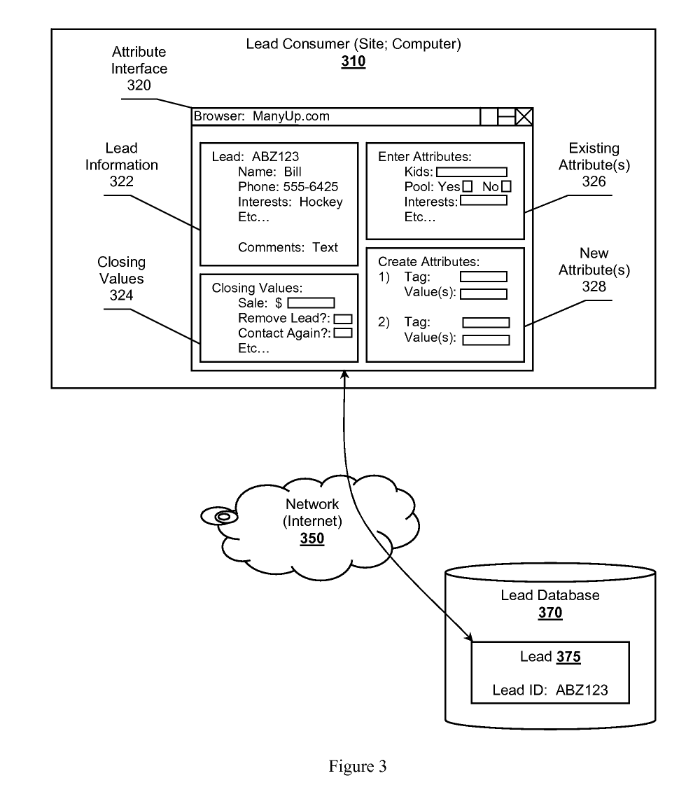

In FIG. 3, lead consumer 310 is provided an attribute interface 320 through which consumer 310 can modify lead attributes or closing values of leads in a lead database as consumer 310 works a lead. It should be noted, that each lead consumer can work leads using their own interface 320, substantially in parallel with each other. Such an approach allows for leads to be constantly improved as multiple lead consumers modify attribute or closing value information.

Attribute interface 30 preferably comprises a web interface that displays various information about a lead (e.g., lead 375) or leads, especially closing values 324, or attributes 326 and 328. Interface 320 could also optionally display lead histories as desired. In a preferred embodiment consumer 310 can modify various values by entering information in provided data entry fields. For example, while a person is working a lead, the person can update the fields for existing attributes 326. Perhaps the person calls an individual associated with a lead and hears children in the background. The person can update the existing “Kids” attribute field by entering the number of children in the household or entering “Yes”. Additionally, once a person completes working a lead, the person can update the fields for closing values 324 by indicating a monetary value of the closed lead, or other information. As a lead is being worked and its fields are modified, the updated information is preferably stored in database 370 by updating lead 375 possibly over network 350. It is also contemplated, assuming proper authentication or authorization, consumer 310 could be allowed to use interface 320 to remove an attribute from lead 375. Attributes can be removed by deleting the corresponding data field of lead 375, or more preferably removing visibility, possibly controlled through meta-tags, of the attribute while retaining the data. Retaining attribute data allows the lead mining service to analyze “removed” attributes even if they are not available to consumers.

Information displayed by interface 320 can be controlled by consumer 310. In a preferred embodiment, when consumer 310 defines a policy for interesting leads, the policy can include rules for displaying desirable information that should be displayed to lead workers. For example, lead consumer 310 could define rules that only allow the display of attributes having meta-tags that indicate that the attributes where defined by consumer 310.

In a preferred embodiment, attribute interface 320 also allows consumer 310 to create new attributes 328 in similar fashion as allowed by policy interfaces 215. Preferably newly created leads 328 can be define by tag-value pairs. It is also contemplated the leads 328 can be automatically meta-tagged with additional information by the lead mining service, or via interface 320. The additional information preferably comprises metadata including who define the attributes, when the attribute was defined, or any other information relating to attributes. Preferably the creation of new attributers 328 is restricted to authorized personnel to reduce unnecessary proliferation of attributes.

Closing values 324, existing attributes 326, or new attributes 328 can be modified using various techniques. Preferred techniques include providing drop down lists of value choices, radio buttons, text or data fields, or other types of data entry.

In a preferred embodiment the lead history of lead 375 is automatically updated, possibly by the lead mining service, in response to a consumer assigning closing values 324 to lead 375. Updating the lead history can include linking the closed lead to a newly created lead as previously discussed. Even if lead 375 is closed by consumer, it could be valuable to other consumers and should be retained. In some embodiments, once a lead is closed by consumer 310, a new lead is created by copying at least some of the attributes from the closed lead to the new lead. The new lead then can link back to the closed lead to form a chain of leads representing the history of the lead. Lead history can also be updated by assigning historical information to the lead, possibly include time of close, identify of consumer 310, state of lead relative to a work-flow process, life stages of an individual associated with the lead, or other information. Lead history information plays an important part in determining the future value of leads as discussed below.

One should note that multiple unaffiliated lead consumers work leads in database 370 substantially at the same time. Consumers update, add, remove, change, or otherwise modify the fields of a lead while working the leads. Although each consumer lacks complete visibility of a lead or its history, the lead mining service has complete visibility of a leads life time. The service can analyze the information available to establish trends or other patterns associated leads having desirable closing values to consumers. The service can then identify other similar leads that could also have desirable closing values.

Predication Set of Leads

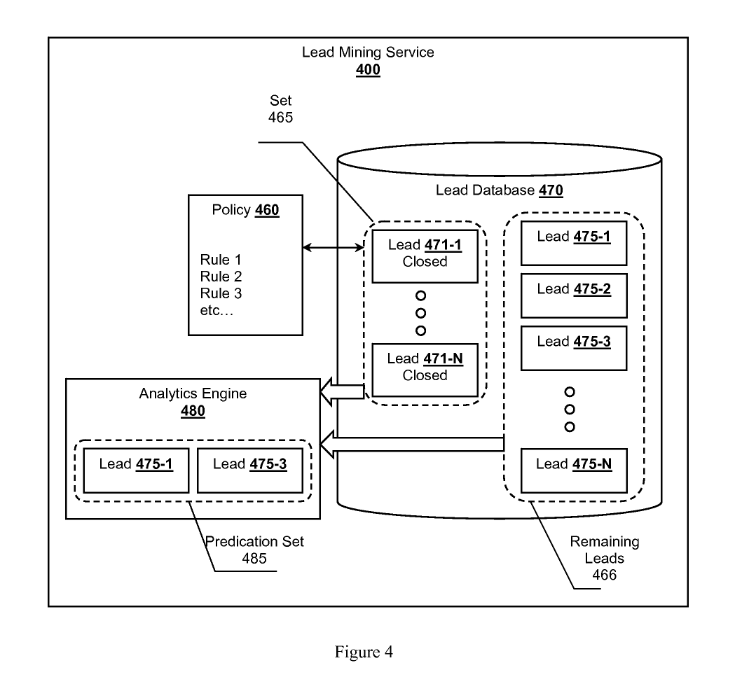

In FIG. 4, lead mining service 400 comprises analytics engine 480 capable of conducting an analysis of leads in database 470 based on their attributes, closing values, lead histories, or other information relating to the leads. In a preferred embodiment analytics engine 480 monitors or analyzes leads 471-1 through 471-N, referred to as leads 471, in set 465 that satisfy policy 460. As a lead consumer closes leads in set 465, leads 471 feed into engine 480, which attempts to establish relationships among the attributes or lead histories of leads 471 with respect to their closing values. Remaining leads 466 also feed into engine 480 as input. If relationships are discovered from set 465, the relationships can be brought bear against leads 475-1 through 475-N, referred to as leads 475, of remaining leads 466. Engine 480 preferably forms a prediction comprising a set of leads, predication set 485, as a function one or more parameters. Preferred parameters include (1) the lead attributes of remaining leads 466 as modified by lead consumers other than the consumer that defined policy 460, (2) the lead histories of remaining leads 466, (3) the closing values of remaining leads 466; and (4) the closing values of leads in set 465 that satisfy policy 460.

Engine 480 comprises a combination of computer hardware or software configured to analyze leads in database 470. In a preferred embodiment engine 480 is local to database 470 to ensure that engine 480 is able to observe changes to database 470. In a preferred embodiment, engine 480 conducts near real-time analysis of leads in database 470 and provides additional leads in less than ten minutes of observing a change to database 470 if the additional leads satisfy policy 460 or are predicated to have an acceptable closing value to a consumer. In more preferred embodiments, engine 480 provides the additional leads in less than five minutes, and yet more preferably in less than one minute of finding the additional leads.

Analytics engine 480 preferably includes automated multi-variate testing algorithms, preferably implemented in hardware or software, the monitors the closing value of leads 471 and 475 with respect to value attributes, lead histories, or other lead information. Any suitable multi-variate testing can be incorporated into the analytics engine including the Taguchi method, which is ordinarily used for quality management. Other acceptable multi-variate testing can be incorporated including regression analysis, canonical variate analysis, principle components analysis, linear discriminate analysis, logistic regression, artificial neural networks to establish non-linear variates, multidimensional scaling, recursive partition, or other analysis methods. In a preferred embodiment, engine 480 can establish linear relationships as well as non-linear relations.

One should note that engine 480 preferably automatically compares closing values of the various leads in database 470, including remaining leads 466 or set 466, to attributes or lead histories to derive potential relationships as opposed to merely comparing lead information with respect to a priori known models. One aspect of the inventive subject includes the automatic discovery or validation of lead mining models that could be applied to leads. One should appreciate that one model for mining leads for a lead consumer does not equally apply to another lead consumer. Preferably the discovered models are tailored to a specific lead consumer. Through the use of one or more types of multi-variate testing, engine 480 can also determine which of lead attributes provides the strongest contribution to an acceptable closing value.

In a preferred embodiment, engine 480 forms a predication comprising a set of one or more leads as represented by predication set 485. The prediction can result from the relationships discovered from analyzing attributes, histories, or closing values of the leads in database 470. A lead can be included in the predication if it has a set of attributes that are considered similar to those leads from set 465 having acceptable closing values. In addition a lead can be included in the predication if it has a lead history similar to lead histories of those in set 465. It is specifically contemplated that engine 480 establishes trends among lead histories and can identify leads still early in their history, but are expect to following the trends.

A preferred predication includes a predicted time when leads in predication set 485 will have an acceptable closing value. For example, engine 480 could monitor or observe the histories of mortgage leads and discover that those leads that obtained a home equity loan purchase goods from a home improvement store within three months. Engine 480 could than form predication set 485 by including leads that recently obtained home equity loans. Engine 480 can further predict that within three months such lead could have acceptable closing values to a home improvement store. Lead mining service can present the leads to a home improvement store lead consumer.

One should appreciate that leads in predication set 485 fail to satisfy policy 460 and are considered out of scope of policy 460 defined by the lead consumer. One aspect of the inventive subject matter is that engine 480 can essentially identify leads that would ordinarily be overlooked by a lead consumer that established policy 460. Through analytics engine 480, the lead mining service 400 is able to provide further improvements of in the quality of leads by monitoring the actual use of the leads and their closing values, then offering leads that are predicated to have acceptable closing values.

Predication set 485 is considered a dynamic, time varying set. As conditions within database 470 change due to a lead consumer or other lead consumers working leads, engine 480 can discover additional leads that should be included, possibly in near real-time (e.g., in less than ten minutes of detecting a change in database 470). It is also contemplated that leads in set 485 could be removed as engine 480 further refines its discovered relationships or models.

Preferably lead mining service 400 also incorporates one or more analysis tools to aid consumers in their analysis of leads. Analysis tools include spreadsheets, graphs, charts, reports, alert notifications, event notifications, trending tools, or other analysis tools. Analysis tools allow consumers to discover trends, review findings of engine 480, or conduct other analyses. In a preferred embodiment, the analysis tools can suggest additional rules that feed back into policy 460. It is contemplated that the feed back could positively or negatively reinforce policy 460. A positive reinforcement could increase the number or the quality of leads. A negative reinforcement could include providing exclusion criteria to reduce the number of leads lacking quality.

Presenting Leads

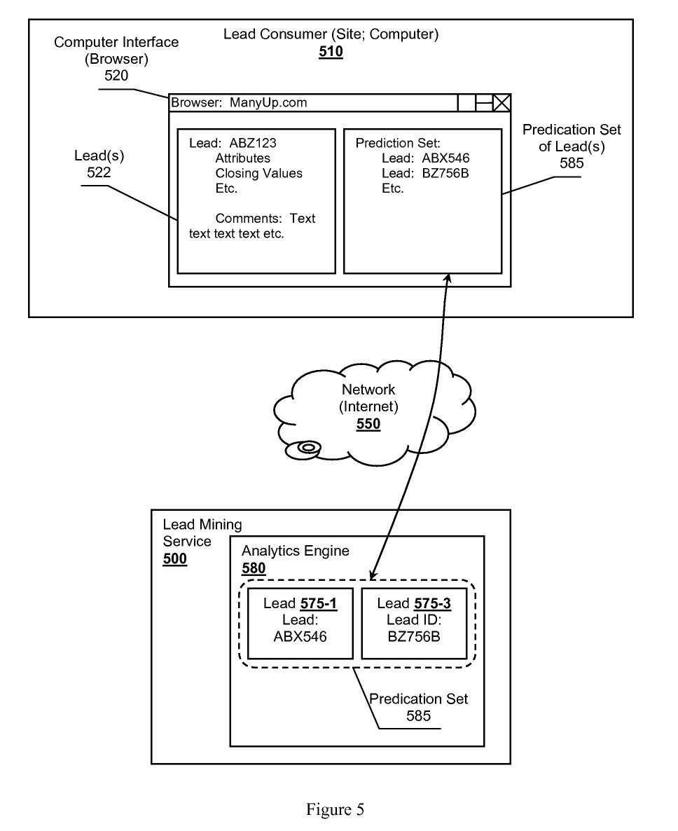

In FIG. 5, predication set of leads 585 comprising leads 573-1 and 575-3 is presented to lead consumer 510 via computer interface 520. In the example shown, interface 520 comprises a web browser interface that displays set 585 by obtaining data from mining service 500 over network 550. However, other interfaces are also contemplated including an application program interface (API), a web services API, a software as a service (SaaS) interface, or other computer based interfaces.

The presentation of predication set 585 can take on many different forms while still falling within the scope of the inventive subject matter. In some embodiments, set 585 is presented as a list of leads for sale, a spreadsheet, a tag cloud, histograms of leads with respect to lead attributes, a ranked listing, a graphic based on geography, or other forms. Regardless of how set 585 is presented, in a preferred embodiment the rendering of the leads can be updated as leads are worked. In some embodiments, set 585 is updated in near real-time (e.g., in less than ten minutes from detecting a change in database 570). For example, set 585 could be presented in the form of listing of leads ranked by probability of achieving an acceptable closing value. The ranking of the leads in the listing could change as new leads enter set 585, leads could be removed, or even pricing could change.

Mining service 500 has access to a wealth of information about leads in database 570, any of which can be presented as part of the presentation of predication set 585. For example, leads of set 585 could be presented along with probability of achieving an acceptable closing value, an expected closing value, a time frame for when a lead is expected to mature, a reason for listing, a selling price, a measure of matching a currently defined lead policy, or other information. For example, set 585 could be presented as a tag cloud where each tag is an attribute and the size of the tag is the number of leads having the attribute.

Lead Mining

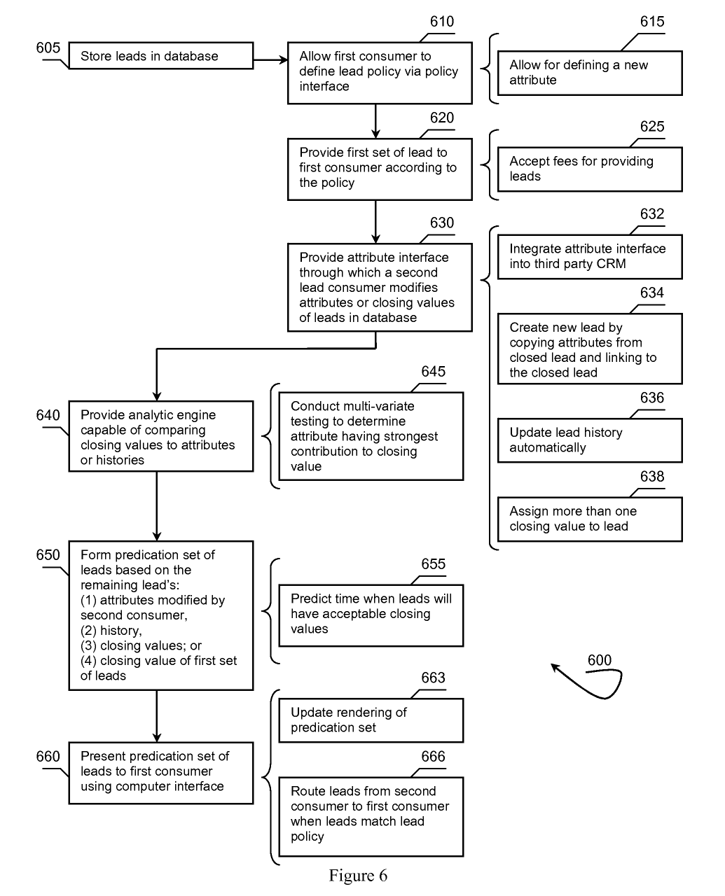

FIG. 6 presents an example method 600 for providing lead mining services. In a preferred embodiment, at step 605, leads are stored in a lead database where each lead is assigned attributes, a lead history, or one or more closing values. The database preferably is operated by a lead mining service offering for-fee services.

At step 610 a lead consumer is allowed to define a lead policy via a policy interface outlining criteria for desirable leads, where the criteria represents rules operating as a function of lead attributers. A lead consumer can define their lead policy once the consumer has been authenticated or authorized. The policy interface can also allow a lead consumer to define a new lead attribute at step 615. The newly defined attributes can comprise tag-value pairs, or can be made available for modification on other leads in the lead database beyond those leads satisfying the lead policies as previously discussed.

In response to having a defined lead policy, at step 620 a lead mining service preferably provides a set of leads from the database to the lead consumer according the lead policy. The service can query its database to find leads that satisfy the policy. In some embodiments, the service could include a policy agent that automatically, possibly on a periodic base, searches the database for new leads that can be forwarded to the consumer. In a preferred embodiment, at step 625 the lead mining service accepts a fee in exchange for providing the set of leads. Fees can include paying a per-lead price, paying an auction price, paying a group price for the set of leads, exchanging goods or services for leads, paying a subscription to the service, or other exchanges for like value.

At step 630, an attribute interface is provided through which another; preferably different lead consumer can modify (e.g., update, add, remove, etc.) attributes or closing values of leads in the lead database. In some embodiments, at step 632 the attribute interface is integrated into a third party CRM software solution, SalesForce.com for example. Preferred attribute interfaces can also allow a lead consumer, assuming proper authorization or granting permission, to create new lead attributes as discussed above.

As consumers work leads from the database, the leads can be updated to reflect newly added attributes, attribute information, lead histories, or closing values. At step 634 it is contemplated upon closing a lead, that a new lead entry in the database can be created by copying at least some of the attributes from the closed lead and linking the lead to the closed lead. The resulting chain of leads forms a lead history that can be used in future analysis. In addition, at step 636 the lead histories of the set of leads can be automatically updated in response to the consumer assigning one or more closing values (see step 638) to at least some of the leads. Preferably, the lead mining service updates lead histories to ensure proper historical records are maintained for later analysis.

In a preferred embodiment at step 640 an analytic engine is provided where the engine is capable of comparing closing values of leads in the lead database to at least some of the attributes or lead histories to establish one or more relationships among the various values. The relationships can then be used to determine patterns or trends associated with the flow or lifetimes of the leads. At step 645 preferred engines conduct multi-variate testing among the remaining leads to determine which from among the attributes provides for the strongest contribution to a closing value as discussed previously. Through analysis of the leads and their attributes, histories, or closing values, the analytics engine preferably discovers statistically significant trends that a human being would be unable to detect.

At step 650 a predication is formed comprising a second set of leads for the lead database. The predication is formed as a function of (1) attributes modified by other lead consumers, (2) lead histories, (3) or closing values of leads remaining in the database; and a function of (4) closing values of leads in the set of leads satisfying the policy defined by the lead consumer. The leads in the second set of leads are preferably predicated to have acceptable closing values to the lead consumer and fall outside the scope of the policy originally defined by the consumer. This approach allows for providing leads to a lead consumer that would ordinarily be overlooked. In some embodiments, at step 655, the predication includes a time when the leads in the second set of leads will have the acceptable closing value. For example, the predicated time can be assigned to the leads as an attribute and can represent a relative time or an absolute time with respect to when a lead will mature.

Once a predication is formed, the second set of leads representing the predication can be presented to the lead consumer at step 660 via a computer interface. Preferred computer interfaces include a web browser interface where a lead consumer accesses lead information over the Internet. In some embodiments, the various interfaces can be the same interface. For example, the computer interface presenting the prediction set of leads can be the same as the attribute interface used to work leads, or the policy interface used to define lead policies. At step 663 it is contemplated the presentation of the leads can be modified by updating the rendering of the presentation as new data is available, or in response to modification by other lead consumers, preferably in near real-time (e.g., in less than ten minutes).

At step 666, an additional lead from another lead consumer can be routed to the lead consumer when the other lead consumer modifies the attributes of the additional lead in a manner that satisfies the policy of the lead consumer. The additional lead could be routed though the lead mining service, or could be routed directly to the lead consumer from the other lead consumer in a peer-to-peer fashion. Preferably peer-to-peer routing occurs once suitable authorization is granted by the lead mining service.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing a lead mining service, the method comprising
storing leads in a lead database where each lead is assigned attributes, a lead history, and a closing value;
allowing a first lead consumer to define a lead policy via a policy interface that defines criteria for desirable leads as a function of the attributes;
providing a first set of leads from the database to the first lead consumer according to the policy;
providing an attribute interface through which a second lead consumer can modify the attributes and the closing value of leads in the database;
forming a prediction comprising a second set of leads from the database as a function of attributes modified by the second lead consumer, the lead histories, and the closing values of remaining leads in the database and as a function of the closing values of the first set of leads, where the second set of leads are predicted to have acceptable closing values to the first lead consumer and are out of scope of the lead policy of the first lead consumer; and
presenting the second set of leads to the first lead consumer via a computer interface.

2. The method of claim 1, wherein the step of providing the set of leads to the first consumer includes accepting a fee in exchange for providing the leads.

3. The method of claim 1, wherein the lead policy includes time-based conditions with respect to the attributes.

4. The method of claim 1, wherein the presenting the second set of leads includes updating a rendering of the second set of leads in near-real time.

5. The method of claim 1, further comprising updating the lead histories of the first set of leads automatically in response to the first consumer assigning closing values to the leads in the first set of leads.

6. The method of claim 1, wherein the closing values comprise a monetary value.

7. The method of claim 1, further comprising providing an analytics engine capable of comparing closing values of the remaining leads with respect to at least one of the attributes, and the lead histories.

8. The method of claim 7, wherein the analytics engine conducts multi-variate testing among the remaining leads to determine which from among the attributes provides for a strongest acceptable closing value.

9. The method of claim 1, further comprising assigning more than one closing value to at least some of the leads.

10. The method of claim 1, further comprising integrating the attribute interface into a third-party CRM.

11. The method of claim 1, further comprising creating a new lead by copying at least some attributes from a closed lead in the first set of leads and linking the new lead to the closed lead.

12. The method of claim 11, wherein the lead history comprises a chain of leads.

13. The method of claim 1, wherein forming the prediction includes predicting a time when leads in the second set will have the acceptable closing values.

14. The method of claim 1, wherein the step of allowing the first consumer to define the lead policy includes allowing the first consumer to define a new attribute.

15. The method of claim 14, wherein the new attribute comprises a tag-value pair.

16. The method of claim 14, wherein the new attribute is available for modification on the remaining leads outside the first set of leads.

17. The method of claim 1, wherein the attribute interface allows for removing attributes from a lead.

18. The method of claim 1, further comprising routing an additional lead from the second lead consumer to the first lead consumer when the second lead consumer modifies the attributes of the additional lead and when the additional lead conforms to the lead policy.

19. The method of claim 1, wherein the step of presenting the second set of leads occurs in near real-time to modification of attributes by the second lead consumer.
